(19) United States
(12) Patent Application Publication
(10) Pub. No.: US 2022/0306820 A1
(43) Pub. Date: Sep. 29, 2022

(54) FORMULATIONS WITH HIGH GLASS TRANSITION TEMPERATURES, FOR LAMINATES

(71) Applicant: Henkel AG & Co. KGaA, Duesseldorf (DE)

(72) Inventors: Konstantinos Markou, Koeln (DE); Mustapha Benomar, Duisburg (DE); Ligang Zhao, Duesseldorf (DE); Hans-Georg Kinzelmann, Pulheim (DE)

(21) Appl. No.: 17/750,595

(22) Filed: May 23, 2022

Related U.S. Application Data
(63) Continuation of application No. PCT/EP2020/082630, filed on Nov. 19, 2020.

(30) Foreign Application Priority Data
Nov. 22, 2019 (EP) 19211024.5

(51) Int. Cl. C08J 5/04; B29C 71/02

(52) U.S. Cl. CPC C08J 5/04; C08J 7/08; C08J 2363/00

(57) ABSTRACT

The present invention relates to curable resin compositions, to methods for producing cured compositions using said curable resin compositions, and to items, in particular molded parts, produced by means of such methods.

The present invention relates to curable resin compositions, to methods for producing cured compositions using said curable resin compositions, and to items, in particular molded parts, produced by means of such methods.

The lightweight construction of automobiles is becoming increasingly important in the automotive industry, with molded parts made of carbon fiber-reinforced plastics material (CFRP) in particular being in increasing demand from the automotive industry. Such molded parts are installed, for example, in the form of rims which are exposed to high temperatures during braking processes. Consequently, it is essential to use matrix resins which have very high glass transition temperatures T_{g} in the cured state when producing the corresponding molded parts, since otherwise a heat-repellent protective lacquer would have to be applied, which would make the production process even more complex. In addition to the highest possible glass transition temperature, it is just as important to equip the system with good impact strength in order to avoid micro-cracks which would result in the escape of air. However, high glass transition temperatures and good impact strength are contrary properties. Although it is known that cycloaliphatic epoxy resins which are cured with anhydrides result in cured materials having high glass transition temperatures, many raw materials which increase the impact strength, such as plasticizers, lower the glass transition temperatures of such matrix systems.

The present invention is based on the discovery by the inventors that by adding organic core-shell particles and inorganic particles, epoxy resin-based curable formulations can be obtained which, in the cured state, have both a high glass transition temperature and excellent impact strength.

The plastic materials obtainable in this way thus demonstrate advantageous mechanical properties and are therefore particularly suitable for use in automobile construction, in particular in the form of fiber-reinforced plastics molded parts.

In a first aspect, the present invention therefore relates to a resin composition comprising at least one epoxy resin component and at least one curing component, characterized in that the resin composition contains, based on the total weight thereof,

(A) 1-30 wt. % particles having a core-shell structure, and
(B) 1-10 wt. % inorganic particles.

A further aspect of the present invention provides a method for producing a cured composition comprising the steps of:

(1) providing a resin composition as described herein; and
(2) curing the resin composition in order to obtain a cured composition.

In a further aspect, the present invention relates to a cured composition obtainable according to a method as described herein.

“At least one,” as used herein, refers to 1 or more, for example 1, 2, 3, 4, 5, 6, 7, 8, 9 or more. In connection with constituents of the catalyst compositions described herein, this statement refers not to the absolute quantity of molecules, but rather to the type of constituent. “At least one epoxy” therefore signifies, for example, one or more different epoxies, i.e., one or more different types of epoxies. Together with stated amounts, the stated amounts refer to the total amount of the correspondingly designated type of constituent, as defined above.

The viscosity of the liquid composition described herein is in particular low enough for the composition to be pumpable and to be able to wet and impregnate fiber materials, for example, as used for fiber-reinforced plastics parts. In various embodiments, the reaction mixture has a viscosity of <100 mPas at a temperature of 100° C. To determine the viscosity, the resin mixture is prepared at room temperature using a suitable mixer and the viscosity is determined in rotation on a plate/plate rheometer with a diameter of 25 mm, a gap of 0.05 mm and a shear rate of 100 s as the temperature increases at a heating rate of 6 K/min.

The present invention relates to resin compositions comprising at least one epoxy resin component and at least one curing component which is further characterized in that further organic particles having a core-shell structure and inorganic particle are contained.

The organic particles having a core-shell structure are preferably rubber particles. The rubber particles having a core-shell structure can all be particulate materials having a rubber core that are known and suitable for the purpose described herein. The rubber core preferably has a glass transition temperature T_{g} of below −25° C., more preferably of less than −50° C., and even more preferably of less than −70° C. The T_{g} of the core can even be well below −100° C. The core-shell particles also have a shell portion which preferably has a T_{g} of at least 50° C.

The “core” here means the inner part of the particle. The core can represent the center of the core-shell particle or an inner sheath or domain of the particle. “Sheath” or “shell” here means the part outside the core which usually forms the outer sheath, i.e., the outermost part of the particle. The shell material is preferably grafted onto or cross-linked to the core. The rubber core can make up 50 to 95 wt. %, in particular 60 to 90 wt. %, of the particle.

The core of the particle can be a polymer or copolymer of a conjugated diene such as butadiene, or a lower alkyl acrylate such as n-butyl, ethyl, isobutyl or 2-ethylhexyl acrylate. The core polymer can additionally contain up to 20 wt. % of further copolymerized monounsaturated monomers such as styrene, vinyl acetate, vinyl chloride, methyl methacrylate and the like. The core polymer is optionally cross-linked. In certain embodiments, it contains up to 5 wt. % of a copolymerized graft monomer which contains two or more unsaturated bonds with different reactivity such as diallyl maleate, monoallyl fumarate, allyl methacrylate and the like, with at least one of the unsaturated bonds not being conjugated.

The core polymer can also be a silicone rubber. These materials often have glass transition temperatures below −100° C. Core-shell particles which have such silicone rubber cores include those that are commercially available from Wacker Chemie (Munich, Germany) under the trade name Genioperl.

The shell polymer which is optionally grafted onto or cross-linked with the core is preferably a polymer of a lower alkyl methacrylate such as methyl methacrylate, ethyl methacrylate or t-butyl methacrylate. Homopolymers of such methacrylates can be used. Furthermore, up to 40 wt. % of the shell polymer can be formed from other vinyl monomers such as styrene, vinyl acetates, vinyl chloride, methyl acrylate, ethyl acrylate, butyl acrylate and the like. The molecular weight of the grafted shell polymer is generally between 20,000 and 500,000.

The rubber particles usually have average particle sizes of from approximately 0.03 to approximately 2 micrometers or from approximately 0.05 to approximately 1 micrometer. In certain embodiments of the invention, the rubber particles have an average diameter of less than approximately 500 nm. In other embodiments, the average particle size is less than approximately 200 nm. For example, the core-shell rubber particles can have an average diameter in the range of from approximately 25 to approximately 200 nm or from approximately 50 to 150 nm.

Methods for making rubber particles having a core-shell structure are well known in the art and are described, for example, in U.S. Pat. Nos. 3,985,703, 4,180,529, 4,315,085, 4,419,496, 4,778,851, 5,223,586, 5,290,857, 5,534,594, 5,686,509, 5,789,482, 5,981,659, 6,111,015, 6,147,142 and 6,180,693, 6,331,580 and 2005/124,761.

The core-shell particles can have reactive groups in the shell polymer that can react with an epoxy resin or an epoxy resin curing agent. For example, glycidyl groups are suitable. Particularly preferred core-shell particles are those which are described in European patent application EP 1 632 533 Al. The core-shell particles described therein include a cross-linked rubber core, in most cases a cross-linked copolymer of butadiene, and a shell which is preferably a copolymer of styrene, methyl methacrylate, glycidyl methacrylate and optionally acrylonitrile.

In various embodiments, core-shell particles are used, as they are described in WO 2007/025007.

The rubber particles having a core-shell structure are preferably dispersed in a polymer or epoxy resin, as also described in the document cited above. Preferred core-shell particles include those available from Kaneka Corporation under the name Kaneka Kane Ace, including Kaneka Kane Ace 15 and the 120 product line, including Kaneka Kane Ace MX 153, Kaneka Kane Ace MX 156, Kaneka Kane Ace MX 257 and Kaneka Kane Ace MX 120 core-shell particle dispersions and mixtures thereof. These products contain the core-shell rubber particles predispersed in an epoxy resin at concentrations of approximately 33 or 25%.

The resin compositions according to the invention preferably contain the core-shell particles in total amounts of from 1 wt. % to 30 wt. %, in particular 15 to 25 wt. %, based in each case on the total weight of the resin composition and the core-shell particles per se, i.e., without any dispersion medium that may be present.

The compositions according to the invention further comprise inorganic particles. Suitable inorganic particles have a particle diameter in the range of from 20 to 400 nm, in particular in the range of from 20 to 300 nm, and even more preferably in the range of from 20 to 250 nm.

According to some embodiments, the inorganic particles are inorganic silicon dioxide particles. Suitable inorganic particles are commercially available, for example, under the name Nanopox from Evonik.

The resin compositions according to the invention preferably contain the inorganic particles in total amounts of from 1 wt. % to 10 wt. %, in particular from 4 to 8 wt. %, based in each case on the total weight of the resin composition.

According to some embodiments, the total amount of organic particles (A) and inorganic particles (B) in the resin compositions according to the invention is in the range of from 1 to 30 wt. %, preferably in the range of from 15-25 wt. %, based in each case on the total weight of the resin composition.

According to the invention, the resin compositions also comprise at least one epoxy resin component. A suitable epoxy resin component comprises one or more epoxy compounds, as described below.

In the context of the present invention, an epoxy resin may comprise epoxide group-containing monomers, prepolymers and polymers as well as mixtures thereof, and is also referred to in the following as epoxide or epoxide group-containing resin. Suitable epoxide group-containing resins are in particular resins having 1 to 10, preferably 2 to 10, epoxide groups per molecule. “Epoxide groups,” as used herein, refers to 1,2-epoxide groups (oxiranes).

The epoxy resins which can be used herein may vary and include conventional and commercially available epoxy resins, each of which may be used individually or in a combination of two or more different epoxy resins. When selecting the epoxy resins, not only are the properties of the final product important but also the properties of the epoxy resin such as the viscosity and other properties which affect processability.

The epoxide equivalent of the polyepoxides can vary between 75 and 50,000, preferably between 170 and 5,000. In principle, the polyepoxides may be saturated, unsaturated, cyclic or acyclic, aliphatic, cycloaliphatic, aromatic or heterocyclic polyepoxide compounds.

According to some embodiments, the at least one epoxy resin component comprises a cycloaliphatic epoxy resin.

Examples of suitable cycloaliphatic epoxides are compounds which have a saturated hydrocarbon ring having an epoxide oxygen atom bonded to two adjacent carbon atoms of the carbon ring, as shown in the following formula:

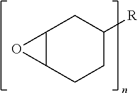

where R is a linking group and n is an integer from 2 to 10, preferably from 2 to 4, and even more preferably from 2 to 3. These are diepoxides or polyepoxides if n is 2 or more. Such cycloaliphatic epoxy resins can have an epoxy equivalent weight of from approximately 95 to 250, in particular from 100 to 150. Mixtures of monoepoxides, diepoxides and/or polyepoxides can be used.

Further examples of suitable cycloaliphatic epoxides are in particular the epoxides of cycloaliphatic esters of dicarboxylic acids such as bis-(3,4-epoxycyclohexylmethyl) oxalate, bis-(3,4-epoxy-cyclohexylmethyl) adipate, bis-(3,4-epoxy-6-methylcyclohexylmethyl) adipate, bis-(3,4-epoxycyclohexylmethyl) pimelate. Further suitable diepoxides of cycloaliphatic esters are described, for example, in U.S. Pat. No. 2,750,395.

Further suitable cycloaliphatic epoxides are, for example, 3,4-epoxycyclohexylmethyl-3,4-epoxycyclohexane carboxylate, bis-(3,4-epoxycyclohexyl) adipate, and 3,4-epoxy-1-methylcyclohexylmethyl-3,4-epoxy-1-methylcyclohexane carboxylate. Further suitable cycloaliphatic epoxides are described, for example, in U.S. Pat. No. 2,890,194.

According to some embodiments, the at least one epoxy resin component comprises an epoxy compound selected from the group consisting of bis-(3,4-epoxycyclohexylmethyl) oxalate, bis-(3,4-epoxycyclohexylmethyl) adipate, bis-(3,4-epoxy-6-methylcyclohexylmethyl) adipate, bis-(3,4-epoxycyclohexylmethyl) pimelate, 3,4-epoxycyclohexylmethyl-3,4-epoxycyclohexane carboxylate, bis-(3,4-epoxycyclohexyl) adipate, 3,4-epoxy-1-methylcyclohexylmethyl-3,4-epoxy-1-methylcyclohexane carboxylate, and mixtures thereof.

Further examples of polyepoxides which are suitable for use in the resin compositions according to the invention include, for example, polyglycidyl ethers prepared by reacting epichlorohydrin or epibromohydrin with a polyphenol in the presence of an alkali. Polyphenols suitable for this are, for example, resorcinol, pyrocatechol, hydroquinone, bisphenol A (bis-(4-hydroxy-phenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane and 1,5-hydroxynaphthaline. Other polyphenols that are suitable as the basis for polyglycidyl ethers are the known condensation products of phenol and formaldehyde or acetaldehyde of the novolac resin type.

Other polyepoxides that are suitable in principle are the polyglycidyl ethers of polyalcohols or diamines. These polyglycidyl ethers are derived from polyalcohols such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other polyepoxides are polyglycidyl esters of polycarboxylic acids, for example reaction products of glycidol or epichlorohydrin with aliphatic or aromatic polycarboxylic acids such as oxalic acid, succinic acid, glutaric acid, terephthalic acid or dimer fatty acid.

Other suitable epoxy resins are known in the prior art and can be found, for example, in Lee H. & Neville, K., Handbook of Epoxy Resins, McGraw-Hill Book Company, 1982 reprint.

Other epoxides are derived from the epoxidation products of olefinically unsaturated cycloaliphatic compounds or from native oils and fats.

Depending on the intended use, it can be preferable for the composition to additionally contain a flexibilizing resin. This may also be an epoxy resin. The inherently known adducts of carboxyl-terminated butadiene-acrylonitrile copolymers (CTBN) and liquid epoxy resins based on the diglycidyl ether of bisphenol A can be used as flexibilizing epoxy resins. Specific examples are the reaction products of Hycar CTBN 1300×8, 1300×13 or 1300×15 from B. F. Goodrich with liquid epoxy resins. Furthermore, the reaction products of amino-terminated polyalkylene glycols (jeffamine) can also be used with an excess of liquid polyepoxides. In principle, reaction products of mercapto-functional prepolymers or liquid Thiokol polymers can also be used according to the invention with an excess of polyepoxides as flexibilizing epoxy resins. However, the reaction products of polymeric fatty acids, in particular dimer fatty acid, with epichlorohydrin, glycidol or in particular diglycidyl ether of bisphenol A (DGBA) are very particularly preferred.

The resin compositions according to the invention further comprise at least one curing component.

According to some embodiments, the at least one curing component comprises at least one anhydride curing agent.

Examples of suitable anhydride-based curing agents are norbornene-based dicarboxylic acid anhydrides. Suitable norbornene-based dicarboxylic acid anhydrides are shown by the following formula:

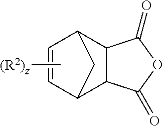

where each R independently represents hydrocarbyl, halogen or inertly substituted hydrocarbyl; z is an integer from 0 to 8, preferably an integer from 0 to 2, in particular from 0 to 1; and R², if present, represents an alkyl group, preferably a methyl group. As used herein, the term “inertly substituted” means that the substituent does not adversely affect the ability of the anhydride group to react with and cure the epoxy resin. In cases where z is 1 or more, preferably at least one R² group is bonded to the carbon atom in position 5. In norbornene-based dicarboxylic acid anhydrides, the dicarboxylic acid anhydride group can be in the exo or endo conformation. In the context of this invention, the two isomers and mixtures of the two isomers are suitable in principle. Preferred examples of a norbornene-based dicarboxylic acid anhydride as described herein are bicyclo[2.2.1]-5-heptene-2,3-dicarboxylic acid anhydride, i.e., an anhydride of the aforementioned structure, where z is 0, and bicyclo[2.2.1]methylhept-5-ene-2,3-dicarboxylic acid anhydride, i.e., an anhydride of the aforementioned structure, where R² is methyl and z is 1, the methyl group preferably being bonded to the carbon atom in position 5. According to some embodiments, the at least one curing component of the resin compositions described herein comprises at least one anhydride curing agent, the at least one anhydride curing agent being selected from bicyclo[2.2.1]-5-heptene-2,3-dicarboxylic acid anhydride, bicyclo[2.2.1]-methylhept-5-ene-2,3-dicarboxylic anhydride, and mixtures thereof. Other suitable anhydride-based curing agents are saturated norbornene-based dicarboxylic acid anhydrides. These are derived from the structures mentioned above, the double bond in the norbornene skeleton being hydrogenated.

Further anhydride curing agents are aliphatic anhydrides such as hexahydrophthalic anhydride, tetrahydrophthalic anhydride, methyltetrahydrophthalic anhydride, methylhexahydrophthalic anhydride, and mixtures thereof, as well as aromatic anhydrides such as phthalic anhydride, trimellitic anhydride, and mixtures thereof. Particularly suitable anhydride curing agents are hexahydrophthalic anhydride, methylhexahydrophthalic anhydride, and mixtures thereof. Further suitable anhydride curing agents are copolymers of styrene and maleic anhydride as well as other anhydrides which are copolymerizable with styrene.

According to preferred embodiments, the at least one curing component of the resin compositions described herein comprises at least one anhydride curing agent, the at least one anhydride curing agent being selected from hexahydrophthalic anhydride, methylhexahydrophthalic anhydride, and mixtures thereof.

Guanidines, substituted guanidines, substituted ureas, melamine resins, guanamine derivatives, cyclic tertiary amines, aromatic amines, and/or mixtures thereof can also be used as thermally activatable or latent curing agents. In this case, the curing agents can be stoichiometrically involved in the curing reaction. However, they may also have a catalytic effect. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and more particularly cyanoguanidine (dicyandiamide). Representatives of suitable guanamine derivatives which may be mentioned are alkylated benzoguanamine resins, benzoguanamine resins or methoxymethyl-ethoxymethyl benzoguanamine. For monocomponent, heat-curing shaped bodies, the selection criterion is the low solubility of these substances at room temperature in the resin system, such that solid, finely ground curing agents are preferred in this case. Dicyandiamide is particularly suitable. Good storage stability of the heat-curable shaped bodies is thereby ensured.

In addition to or instead of the aforementioned curing agents, substituted ureas that have a catalytic effect can be used. These are in particular p-chlorophenyl-N,N-dimethylurea (monuron), 3-phenyl-1,1-dimethylurea (fenuron) or 3,4-dichlorophenyl-N,N-dimethylurea (diuron). In principle, it is also possible to use tertiary acrylic or alkyl amines that have a catalytic effect, for example benzyldimethylamine, tris(dimethylamino)phenol, piperidine or piperidine derivatives. However, these often have too high a solubility in the adhesive system, such that the monocomponent system is not suitably storage stable. Furthermore, various, preferably solid, imidazole derivatives can be used as accelerators that have a catalytic effect. Representative examples include 2-ethyl-2-methylimidazole, N-butylimidazole, benzimidazole and N—C₁₋₁₂-alkylimidazoles or N-arylimidazoles. Particularly preferred is the use of a combination of a curing agent and an accelerator in the form of what is referred to as accelerated dicyandiamides in a finely ground form. This means that it is superfluous to separately add accelerators that have a catalytic effect to the epoxide curing system.

The compositions according to the invention can also be formulated as two-component compositions in which the two reaction components are only mixed with one another shortly before application, curing then taking place at room temperature or at a moderately elevated temperature. The reaction components known per se for two-component epoxy compositions can be used as the second reaction component, for example di- or polyamines, amino-terminated polyalkylene glycols (e.g., jeffamines or amino-poly-THF) or polyaminoamides. Further reactive partners can be mercapto-functional prepolymers such as the liquid Thiokol polymers, and the epoxy compositions according to the invention can also preferably be cured in 2K formulations with carboxylic acid anhydrides as the second reaction component.

The present invention also relates to a method for producing a cured composition comprising the steps of: (1) providing a resin composition as described above; and (2) curing the resin composition in order to thereby obtain a cured composition.

Correspondingly cured compositions have an increased mechanical stability, in particular an increased impact toughness, without lowering the glass transition temperature, and therefore the compositions obtained can be exposed to elevated temperatures during manufacture and their intended use. Said polyols are therefore particularly suitable for the production of fiber-reinforced plastics shaped parts such as automobile parts.

“Providing,” as used herein, refers to mixing the constituents of the resin composition in any sequence. It can be advantageous, for example, first to combine two or more constituents and optionally mix them to form a heterogeneous or homogeneous mixture before the remaining constituents are added. For example, the at least one epoxy resin component can first be mixed with the organic and/or inorganic particles and then, for example shortly before curing, the at least one curing component can be added and mixed into the other constituents which have already been mixed through. It can be advantageous to cool the reaction mixture to room temperature between the various combining and mixing steps. In another embodiment, it can be advantageous to heat the reaction mixture in order to improve the solubility between the various combining and mixing steps.

In general, the individual constituents of the resin composition can be used per se or as a solution in a solvent, for example an organic solvent or a mixture of organic solvents. For this purpose, every known solvent that is suitable for the purpose according to the invention can be used. The solvent can be a high-boiling organic solvent, for example. The solvent can be selected from the group consisting of petroleum, benzene, toluene, xylene, ethyl benzene, and mixtures thereof.

The resin composition described herein can be combined with other constituents known from the prior art in the form of an adhesive composition or an injection resin.

Adhesive compositions or injection resins of this kind can contain many other components, all of which are known to a person skilled in the art, including, but not limited to, frequently used auxiliaries and additives, for example fillers, plasticizers, reactive and/or nonreactive diluents, mobile solvents, coupling agents (e.g., silanes), release agents, adhesion promoters, wetting agents, adhesion agents, flame retardants, wetting agents, thixotropic agents and/or rheological auxiliaries (e.g., pyrogenic silicic acid), aging and/or corrosion inhibitors, stabilizers and/or dyes. Depending on the requirements of the adhesive or the injection resin and the application thereof and with respect to the production, flexibility, strength and adhesion to substrates, the auxiliaries and additives are worked into the composition in different amounts.

In preferred embodiments, the compositions of the invention do not contain plasticizers, or contain less than 0.1 wt. % plasticizers, since these tend to lower the T_{g}.

In various embodiments of the invention, depending on the desired use, the resin composition is applied to a substrate, for example when being used as an adhesive, or filled into a die or when being used as a molding material for producing plastics parts. In preferred embodiments, the method is a transfer molding (RTM) method and the resin composition is a reactive injection resin. “Reactive,” as used in this context, refers to the fact that the injection resin is chemically crosslinkable. In the RTM method, providing the resin composition, i.e., step (1) of the described method, can comprise filling, in particular injecting, the injection resin into a die. In the production of fiber-reinforced plastics parts for which the described method and reaction mixtures are particularly suitable, fibers or semi-finished fiber products (prewovens/preforms) can be placed into the die before injection into said die. Materials known in the prior art for this application, in particular carbon fibers, can be used as the fibers and/or semi-finished fiber products.

In various embodiments, resin compositions of this kind are adhesive compositions or injection resins. The injection resins are preferably pumpable and in particular suitable for transfer molding (RTM method). In various embodiments, the reaction mixture therefore has a viscosity of <100 mPas at a temperature of 100° C., i.e., a typical infusion temperature.

In one embodiment, the invention therefore also relates to the molded parts which can be obtained in the RTM method by means of the resin systems according to the invention. RTM methods in which the described resin systems can be used are known per se in the prior art and can be readily adapted by a person skilled in the art such that the reaction mixture according to the invention can be used.

The open times of the resin compositions, as described herein, are preferably greater than 90 seconds and are preferably in the range of from 2 to 5 minutes, in particular are approximately 3 minutes. “Approximately,” as used herein in relation to a numerical value, means the numerical value±10%.

Depending on the type of epoxides and curing agents used and the use of the cured composition, the resin composition in step (2) of the method according to the invention can be cured at different reaction temperatures. The curing temperature can thus be between 70° C. and 280° C.

The curing process can generally be carried out at an elevated temperature, i.e., >25° C. The resins are preferably cured between 80° C. and 280° C. and more preferably between 100° C. and 240° C. The duration of the curing process likewise depends on the resins to be cured and on the catalyst composition and can be between 0.01 hours and 10 hours. The curing cycle preferably lasts a few minutes, i.e., in particular 1 to 15 minutes. The curing process can also take place in one or more steps.

In some embodiments, the resin composition described herein is cured in a one-step method at a temperature of between 100° C. and 240° C., preferably between 160° C. and 240° C., and more preferably between 180° C. and 240° C., for 0.01 hours to 10 hours, preferably for 0.1 hours to 5 hours, and more preferably for 1 hour.

In alternative embodiments, a resin composition as described herein can be cured in a multi-step method. Such a multi-step method includes a first step of pre-curing, the resin composition being pre-cured at a temperature of between 110° C. and 200° C., preferably 130° C. and 190° C., and more preferably at 180° C., for 0.1 hours to 3 hours, preferably for 0.5 hours to 2 hours, more preferably for 1 hour, and is then post-cured in a second step. This second step of post-curing can comprise one or more sub-steps such that the pre-cured resin composition is post-cured at least once, preferably at least twice, and more preferably at least three times, in each case at a temperature of between 110° C. and 260° C., preferably 130° C. and 190° C., and more preferably at 180° C., in each case for 0.1 hours to 3 hours, preferably for 0.5 hours to 2 hours, and more preferably for 1 hour. For example, such a second curing step can comprise post-curing the pre-cured resin composition at a temperature of between 130° C. and 230° C., preferably 180° C. and 220° C., and more preferably at 200° C., for 0.1 hours to 3 hours, preferably for 0.5 hours to 2 hours, and more preferably for 1 hour; then at a temperature of between 150° C. and 250° C., preferably between 190° C. and 230° C., and more preferably at 220° C., for 0.1 hours to 3 hours, preferably for 0.5 hours to 2 hours, and more preferably for 1 hour; and then at a temperature of between 170° C. and 260° C., preferably 200° C. and 250° C., and more preferably at 240° C., for 0.1 hours to 3 hours, preferably for 0.5 hours to 2 hours, and more preferably for 1 hour.

The resins cured as described herein preferably have a critical stress intensity factor K1c of ≥0.8, preferably ≥0.9, more preferably ≥0.95, and most preferably ≥1.0. In various embodiments, the glass transition temperature of the cured resins is in the range of ≥250° C., in particular ≥255° C., and typically in the range of up to 300° C. The modulus of elasticity of the cured resins is preferably at least 2,000 N/mm², more preferably at least 2,100 N/mm², and typically in the range of from 2,200 to 5,000 N/mm².

Moreover, the present invention relates to the cured composition which can be obtained according to the method described herein. Depending on the method, said composition can be present as a molded part, in particular as a fiber-reinforced plastics molded part. Such molded parts are preferably used in automobile construction or aerospace.

The cured compositions are thus particularly suitable as a matrix resin for fiber composite materials. These can be used in various methods of application, for example in the resin transfer molding method (RTM method) or in the infusion method.

Known high-performance fiber materials are suitable as fiber constituents of the fiber composite materials. These can consist, for example, of glass fibers; synthetic fibers such as polyester fibers, polyethylene fibers, polypropylene fibers, polyamide fibers, polyimide fibers or aramid fibers; carbon fibers; boron fibers; oxide or non-oxide ceramic fibers such as aluminum oxide/silicon dioxide fibers, silicon carbide fibers; metal fibers, for example made of steel or aluminum; or of natural fibers such as flax, hemp or jute. Said fibers can be incorporated in the form of mats, woven fabrics, knitted fabrics, non-woven fabrics, fibrous webs or rovings. Two or more of these fiber materials may also be used as a mixture. Short cut fibers can be selected, but preferably synthetic long fibers are used, in particular woven and non-woven fabrics. Such high strength fibers, non-woven fabrics, woven fabrics and rovings are known to a person skilled in the art.

In particular, the fiber composite material should contain fibers in a volume percentage of more than 40 vol. %, preferably more than 50 vol. %, particularly preferably between 50 and 70 vol. %, based on the total fiber composite material, in order to achieve particularly good mechanical properties. In the case of carbon fibers, the volume percentage is determined according to standard DIN EN 2564:1998-08 and in the case of glass fibers, it is determined according to standard DIN EN ISO 1172:1998-12.

A fiber composite material of this kind is suitable in particular as an automobile part. Compared with steel, such fiber composite components have several advantages, i.e., they are lighter in weight, are characterized by improved crash resistance and are also more durable.

Moreover, it goes without saying that all embodiments that have been disclosed above in connection with the method according to the invention can also be applied in the same manner in the described resin systems and cured compositions, and vice versa.

### EXAMPLES

### Example Formulation 1

Epoxy Resin Component:

97.7 g cycloaliphatic epoxy having 30% organic core-shell structure particles
4.1 g organic core-shell structure particles
42.5 g cycloaliphatic epoxy having 40% SiO₂ particles
3.0 g multi-functional fatty acid ester (release agent)

Curing Component:

132.0 g mixture of bicyclo[2.2.1]-5-heptene-2,3-dicarboxylic acid anhydride and bicyclo[2.2.1]methylhept-5-ene-2,3-dicarboxylic acid anhydride
2.0 g 1-methylimidazole

The epoxy resin component and the curing component were homogenized and then poured into a steel mold. The pre-curing took place at 130° C. over a period of 30 minutes. The mixture was then post-cured for one hour at 180° C., for one hour at 200° C., for one hour at 220° C. and finally for one hour at 240° C. in order to ensure complete cross-linking. In this way, polymer plates approximately 4 mm thick with an area of 20 cm×20 cm were produced.

The total amount of organic particles was approximately 12%; the total amount of inorganic particles was approximately 6%. The physical properties of the plate produced in this way are clearly summarized in the table below.

TABLE 1
Physical properties of example composition 1

| | |
|---|---|
| Flexural modulus [MPa] | 2,159 |
| Flexural strength [MPa] | 96 |
| K1c [MPa*m½] | 1.0 |
| Tg DMA tan delta [° C.] | 280 |
| Tg DMA E′ onset [° C.] | 255 |

### Example Formulation 2

Epoxy Resin Component:

81.6 g cycloaliphatic epoxy having 30% core-shell structure particles
3.4 g core-shell structure particles
60.0 g cycloaliphatic epoxy having 40% SiO₂ particles
3.0 g multi-functional fatty acid ester (release agent)

Curing Component:

132.0 g mixture of bicyclo[2.2.1]-5-heptene-2,3-dicarboxylic acid anhydride and bicyclo[2.2.1]methylhept-5-ene-2,3-dicarboxylic acid anhydride
2.0 g 1-methylimidazole

The epoxy resin component and the curing component were homogenized and then poured into a steel mold. The pre-curing took place at 130° C. over a period of 30 minutes. The mixture was then post-cured for one hour at 180° C., for one hour at 200° C., for one hour at 220° C. and finally for one hour at 240° C. in order to ensure complete cross-linking. In this way, polymer plates approximately 4 mm thick with an area of 20 cm×20 cm were produced.

The total amount of organic particles was approximately 10%; the total amount of inorganic particles was approximately 8%. The physical properties of the plate produced in this way are clearly summarized in the table below.

TABLE 2
Physical properties of example composition 2

| | |
|---|---|
| Flexural modulus [MPa] | 2,400 |
| Flexural strength [MPa] | 96 |
| K1c [MPa*m½] | 0.9 |
| Tg DMA tan delta [° C.] | 275 |
| Tg DMA E′ onset [° C.] | 250 |

### Comparative Example

Epoxy Resin Component:

137.0 g cycloaliphatic epoxy with 30% core-shell structure particles
3.0 g multi-functional fatty acid ester (release agent)

Curing Component:

137.0 g mixture of bicyclo[2.2.1]-5-heptene-2,3-dicarboxylic acid anhydride and bicyclo[2.2.1]methylhept-5-ene-2,3-dicarboxylic acid anhydride
2.0 g 1-methylimidazole

The epoxy resin component and the curing component were homogenized and then poured into a steel mold. The pre-curing took place at 130° C. over a period of 30 minutes. The mixture was then post-cured for one hour at 180° C., for one hour at 200° C., for one hour at 220° C. and finally for one hour at 240° C. in order to ensure complete cross-linking. In this way, polymer plates approximately 4 mm thick with an area of 20 cm×20 cm were produced.

The total amount of organic particles was approximately 15%. The physical properties of the plate produced in this way are clearly summarized in the table below.

TABLE 3
Physical properties of the comparative example composition

| | |
|---|---|
| Flexural modulus [MPa] | 2,182 |
| Flexural strength [MPa] | 79 |
| K1c [MPa*m½] | 0.7 |
| Tg DMA tan delta [° C.] | 281 |
| Tg DMA E′ onset [° C.] | 252 |

The direct comparison of the two example formulations 1 and 2 according to the present invention with the formulation of the comparative example shows that a combination of organic core-shell structural particles and inorganic particles in cycloaliphatic epoxy resin compositions results in an increase in the K1c value, without the glass transition temperature of the cured composition being lowered.

What is claimed is:

1. A resin composition comprising at least one epoxy resin component at least one curing component and based on the total weight thereof,
(A) 1-30 wt. % particles having a core-shell structure, and
(B) 1-10 wt. % inorganic particles.

2. The resin composition according to claim 1, characterized in that the at least one epoxy resin component comprises a cycloaliphatic epoxy resin.

3. The resin composition according to claim 1, characterized in that
(a) the total amount of particles (A) and particles (B) is in the range of from 1 to 30 wt. % based in each case on the total weight of the resin composition; and/or
(b) the amount of inorganic particles (B) is in the range of from 4-8 wt. %; and/or
(c) the particles (A) and the particles (B) are contained in the epoxy resin component.

4. The resin composition according to claim 1, characterized in that the at least one epoxy resin component is an epoxy compound selected from the group consisting of bis-(3,4-epoxycyclohexylmethyl) oxalate, bis-(3,4-epoxycyclohexylmethyl) adipate, bis-(3,4-epoxy-6-methylcyclohexylmethyl) adipate, bis-(3,4-epoxycyclohexylmethyl) pimelate, 3,4-epoxycyclohexylmethyl-3,4-epoxycyclohexane carboxylate, bis-(3,4-epoxycyclohexyl) adipate, 3,4-epoxy-1-methylcyclohexylmethyl-3,4-epoxy-1-methylcyclohexane carboxylate, and mixtures thereof.

5. The resin composition according to claim 1, characterized in that the at least one curing component comprises at least one anhydride curing agent.

6. The resin composition according to claim 5, characterized in that the at least one anhydride curing agent is selected from bicyclo[2.2.1]-5-heptene-2,3-dicarboxylic acid anhydride, bicyclo[2.2.1]methylhept-5-ene-2,3-dicarboxylic acid anhydride, and mixtures thereof.

7. A method for producing a cured composition comprising the steps of:
(1) providing a resin composition according to claim 1; and
(2) curing the resin composition in order to obtain a cured composition.

8. The method according to claim 7, characterized in that the method is a transfer molding (RTM) method and the resin composition is a reactive injection resin.

9. The method according to claim 7, characterized in that step (1) comprises injecting the resin composition into a die in which fibers or semi-finished fiber products (prewovens/preforms) are placed.

10. The method according to claim 7, characterized in that
(a) the resin composition in step (2) is cured at a temperature of between 100° C. and 240° C., for 0.01 to 10 hours; or
(b) the resin composition in step (2) is first pre-cured at a temperature of between 70° C. and 150° C., for 0.1 to 3 hours and is then post-cured at least once, in each case at a temperature of between 110° C. and 260° C., in each case for 0.1 to 3 hours.

11. A cured composition obtainable according to a method to claim 7.

12. The cured composition according to claim 11, characterized in that the K1c value of the cured composition is at least 0.8.

13. The cured composition according to claim 11, characterized in that the cured composition has a glass transition temperature T_{g}≥250° C.

14. The cured composition according to claim 11, characterized in that the cured composition is a molded part, in particular a fiber-reinforced molded part.
